(19) United States
(12) Patent Application Publication
(10) Pub. No.: US 2022/0241661 A1
(43) Pub. Date: Aug. 4, 2022

(54) HOCKEY STICK HAVING A HEATED BLADE

(71) Applicants: Rafael P. Squitieri, Wilton, CT (US); John Squitieri, Wilton, CT (US)

(72) Inventors: Rafael P. Squitieri, Wilton, CT (US); John Squitieri, Wilton, CT (US)

(21) Appl. No.: 17/369,614

(22) Filed: Jul. 7, 2021

Related U.S. Application Data
(60) Provisional application No. 63/145,473, filed on Feb. 3, 2021.

(51) Int. Cl. A63B 59/70; A63B 60/42; H05B 1/02

(52) U.S. Cl. CPC A63B 59/70; A63B 60/42; A63B 2102/24; A63B 2225/64; H05B 1/0202

(57) ABSTRACT

A heated hockey stick includes a heating system having a power source contained within the shaft of the hockey stick, a heating element within the blade of the hockey stick connected to the power source and configured to heat at least the blade of the hockey stick. An actuatable switch device may be employed to manually or automatically for enable or disable the power source. The hockey stick may include structure to enable adjustment of the length of the shaft of the heated hockey stick. An external heating device may be used in conjunction with the present heated hockey stick.

### CROSS-REFERENCE TO RELATED APPLICATIONS

This application claims the benefit of U.S. Provisional Application No. 63/145,473, filed Feb. 3, 2021, the entire disclosure of which is incorporated herein by reference for all purposes.

### BACKGROUND

Hockey is a high paced, physically demanding sport that requires high levels of skill and endurance. Hockey players use hockey sticks to pass the puck to other players and to shoot at the opposing team's net to score goals. Slight improvements to a hockey stick's maneuverability, responsiveness and performance can have a significant impact on a given player's control and overall performance. Thus, hockey players often make minor modifications to their hockey sticks. For example, tape may be placed around the blade and handle of the hockey stick, or wax may be applied to the blade of the stick to increase performance and functionality.

Ice may build up on the blade of the hockey stick during play. The buildup of ice or frost on the blade of a hockey stick interferes with the interaction between the stick and the puck, decreasing performance of the hockey stick and a given player's control of the puck. Additionally, ice buildup on a hockey stick can negate or hinder the beneficial effects of certain modifications, such as the addition of tape and wax. Removal of ice buildup could significantly improve stick performance, thereby improving a given player's control.

Thus, it would be desirable to provide a hockey stick configured to be heated, thereby preventing the buildup of ice on the hockey stick.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

In one aspect, the present disclosure relates to A heated hockey stick including a shaft, a blade secured to a lower portion of the shaft, a power source contained within the shaft, and a heating element connected to the power source, the heating element configured to heat at least the blade of the hockey stick when the power source is enabled. In embodiments, the heating element generates heat using electricity, battery power, conduction, convection, or chemical reactions.

In embodiments, the heating element is contained within the blade of the hockey stick. In embodiments, the heating element is a heating coil. In embodiments, the power source is a battery. In embodiments, the battery is rechargeable.

In embodiments, the power source is coupled to a switch device, the switch device being actuatable, such that when the switch is actuated, the power source is enabled. In embodiments, the switch device is actuated manually. In other embodiments, the switch device is actuated automatically, and is contained in the shaft of the hockey stick. In embodiments, the power source is coupled to a control unit. The control unit may be configured to automatically monitor the temperature of the blade of the hockey stick. In embodiments, the control unit is further configured to actuate the switch device, thereby enabling the power source, when the blade of the hockey stick is below a set temperature.

In embodiments, a heated hockey stick may further include a thermal structure including a thermal store for prolonging maintenance of the heat generated by the heating element within the blade. In embodiments, the thermal store comprises materials of varying phases, gels, or rice.

### BRIEF DESCRIPTION OF THE DRAWINGS

The above and other aspects, features, and advantages of the present hockey sticks will become more apparent in light of the following detailed description when taken in conjunction with the accompanying drawings in which:

FIG. 1 shows a representative hockey stick;

FIG. 2 shows an illustrative heating system within the shaft of a hockey stick in accordance with the present disclosure;

FIG. 2A schematically shows an illustrative heating system in accordance with the present disclosure;

FIG. 3 shows a hockey stick in accordance with another aspect of the present disclosure including contact members for adjusting the length of the shaft of the hockey stick; and

FIG. 4A-C show various external heating mechanisms that may be used with heated hockey sticks in accordance with the present disclosure.

### DETAILED DESCRIPTION

Particular embodiments of the present heated hockey sticks are described hereinbelow with reference to the accompanying drawings; however, it is to be understood that the disclosed embodiments are merely exemplary of the disclosure and may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Well-known functions or constructions are not described in detail to avoid obscuring the present disclosure in any unnecessary detail.

While the following disclosure is presented with respect to heated hockey sticks, it should be understood that certain features of the present disclosure may be readily adapted for use in any type of athletic equipment having a stick or other implement exposed to ice or freezing temperatures during use.

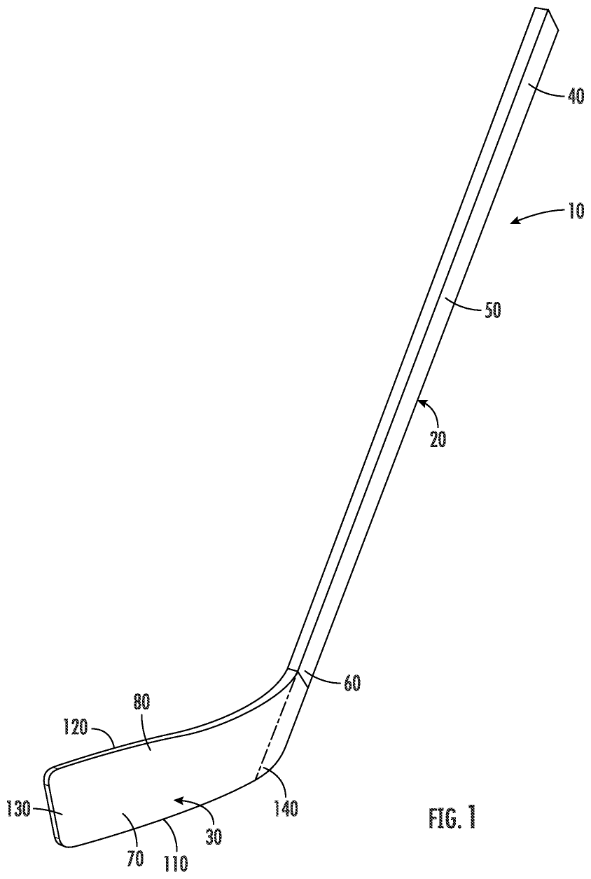

FIG. 1 depicts an illustrative hockey stick 10 including a blade 30 and a shaft 20 joined thereto. Externally, the blade 30 includes a lower section 70, an upper section 80, a bottom edge 110, a top edge 120, a tip section 130, and a heel section 140, which generally resides behind the tip section 130 of the blade 30 between the plane defined by the top edge 120 and the plane defined by the bottom edge 110 of the blade 30. The shaft 20 includes an upper section 40, a mid-section 50, and a lower section 60, which is adapted to being interposed or joined within a slot not explicitly shown) located in the heel section 140 of the blade. Blade 30 may be constructed of various materials including wood, wood laminates, wood laminate overlain with fiberglass, and what is often referred to in the industry as “composite” constructions. Such composite blade constructions may employ what is generally referred to as a structural sandwich construction, which includes a low-density rigid core faced on generally opposed front and back facing surfaces with a thin, high strength, skin or facing. The skin or facing may be made from plies of woven and substantially continuous fibers, such as carbon, glass, graphite, or Kevlar™ disposed within a hardened matrix resin material.

Shaft 20 may be formed as a hollow tubular structure. In embodiments, the hollow tubular structure of shaft 20 may further include grooves (not shown) formed on one or more of the walls of the shaft, configured to receive wires or other desired components. For more details on the construction and configuration of hockey stick 10, reference may be made to U.S. Pat. No. 7,232,386, the entire disclosure of which is incorporated herein by reference.

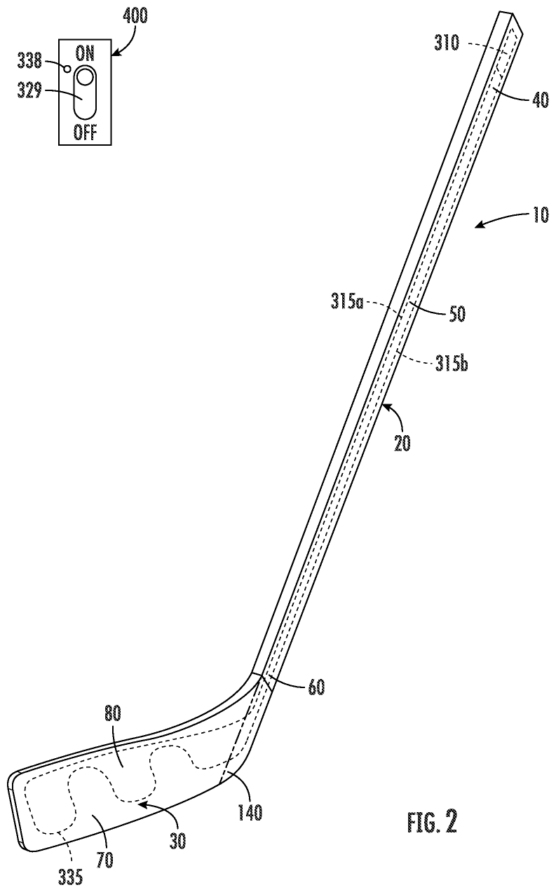

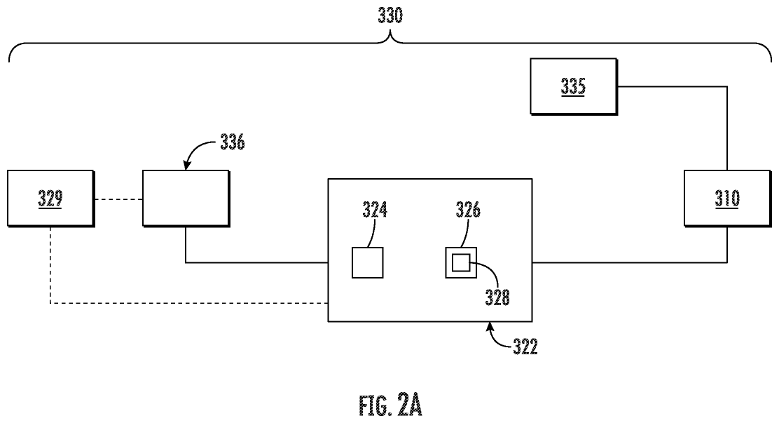

FIG. 2 shows a heating system 300 contained within hockey stick 10. Heating system 300 (shown in phantom because it is located within hockey stick 10) includes a power source 310 in upper section 40 of shaft 20, wires 315a, 315b extending from upper section 40 through mid-section 50, and to lower section 60 of shaft 20, and a heating element 335 contained in blade 30. While shown positioned within upper section 40 of shaft 20, it should of course be understood that power source 310 may be located within mid-section 50 or lower section 60 of shaft 20. In addition, an access door (not shown) may, in embodiments, be provided to allow access to (e.g., for charging or replacement of) the power source.

Heating element 335, while shown as a sinusoidal configuration, may be arranged in any configuration within blade 30. Also, while shown extending for substantially the entire width of blade 30 (i.e., from near top edge 120 to near bottom edge 110 of blade 30), it should be understood that heating element 335 may be positioned closer to bottom edge 110 (which is in contact with the ice and more likely to experience ice or frost build up) and not be present adjacent top edge 120 of blade 30. Other configurations for heating element 335 will be readily apparent to one skilled in the art reading this disclosure.

Power source 310 may be a battery, for example one or more lithium ion cells, Nickel Metal Hydride (NiMH), and/or some other electrical storage technology available at the time of the present writing or hereafter developed that provides adequate mA while at the same time meeting desired size and weight specifications to fit within shaft 20 without unduly burdening a user.

In embodiments, heating element 335 may be a heating coil. The heating coil may be coupled to the power source 310 via wires 315a, 315b. Power source 310 may be configured to send an electric current ranging from 50 to 450 kHz through the heating coil. In embodiments, the heating coil may be a copper wire. In other embodiments, the heating coil may be various metals having a desirable, low resistance, such as silver, gold, aluminum or any other suitable metal. In other embodiments, heating element 335 may be any resistive heaters and like devices that generate heat in response to the electrical stimulus from the power source 310. Suitable resistive heaters may have any one of many form factors, including flat, tubular, coil, etched, or rod-like. The resistive heaters may include various materials including silicone rubber, polyimide film, metal wire, metal foils, and ceramics, among others. Heating element 335 may transfer thermal energy to blade 30 of hockey stick 10 by way of direct or indirect heat transfer modalities (e.g., conduction, convection, radiation, etc.) depending on the positioning of heating element 335 within blade 30. In embodiments, a heating element may be added to an existing hockey stick on an outer portion of the hockey stick. For example, in embodiments, heating element 335 may be positioned outside and around blade 30 and then substantially covered with a suitable protective material capable of both protecting the blade and retaining thermal energy, such as hockey stick tape.

FIG. 2A shows an illustrative automatic heating system 330 in isolation, including heating element 335 and a sensor 336. When power source 310 provides an electrical stimulus (e.g., current and/or voltage) to the heating element 335, the power source 310 may be adjustable for proportionate temperature settings on the heating element. Sensor 336 may be a bi-metal disc thermostat. Sensor 336 may also be a thermistor, thermocouple, or similar device that can generate a signal in response to temperature of blade 30. These devices may be affixed to an inner portion of blade 30 using adhesives or other suitable affixing methods. In embodiments, the heating element 335 may include a control unit 322 to regulate this electrical stimulus. The control unit 322 may have one or more processors 324, storage memory 326, and executable instructions 328, that reside and/or are stored on the storage memory 326. This configuration may be useful to communicate with at least the sensor 336 and the power supply 310 to regulate the electrical stimulus to the heating element 335. For example, the executable instructions 328 can embody computer programs (e.g., software, firmware, etc.) that can configure the processor 324 to turn the power source 310 on-and-off in response to the signal from the sensor 336 when a set temperature is reached. In one implementation, the heating system 300 may also include a switch device 329 that couples with the power source 310 and/or the control unit 322. Switch device 329 may be contained in a remote control 400, as shown in FIG. 2, or in embodiments, may be positioned within, and exposed to a user through a surface of shaft 20 of hockey stick 10.

Switch device 329 can include push button and or actuatable devices that are configured to allow a player to regulate the electrical signal from the power source 310 to the heating element 335. Such configurations may allow for manual control of the heating element 335, although automated control via the control unit 322 may also cause the switch to actuate as necessary to turn heating element 335 on or off as desired.

In embodiments, switch device 329 used to enable or disable heating element 335 further includes an LED 338 to indicate the operating status of heating element 335 (i.e. on or off). A printed circuit board (PCB, not shown) may be connected to switch device 329 and positioned within the shaft 320 of the hockey stick 300. The PCB (not shown) may be connected to a conductor that engages a positive terminal of power source 310. The PCB may also be connected to a conductor that is adapted to electrically engage a negative terminal of the power source 310. In embodiments, a recess may be formed within shaft 320 for positioning a recharge jack (not shown). The recharge jack may be electrically connected to power source 310 for charging or recharging.

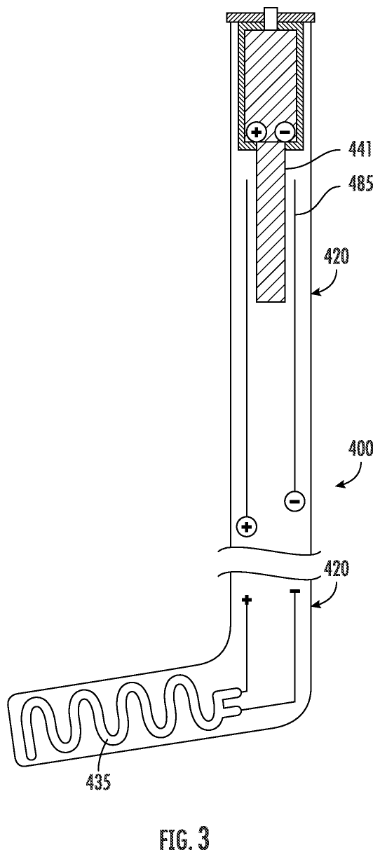

In embodiments, as shown in FIG. 3, a hockey stick 400 in accordance with the present disclosure may have a shaft 420 that is adjustable in length. Shaft 420 may be lengthened or shortened by manipulating an adjustable contact 441 that may be moved or slid upwards or downwards. In embodiments, shaft 420 may include telescopic members for adjusting the length of the shaft as recited in U.S. Pat. No. 5,609,336, the entire disclosure of which is incorporated herein by reference. In embodiments including adjustable shafts, an external heating element may be used alone, or in combination with previously described heating elements to supplement the process of de-icing a given hockey stick blade.

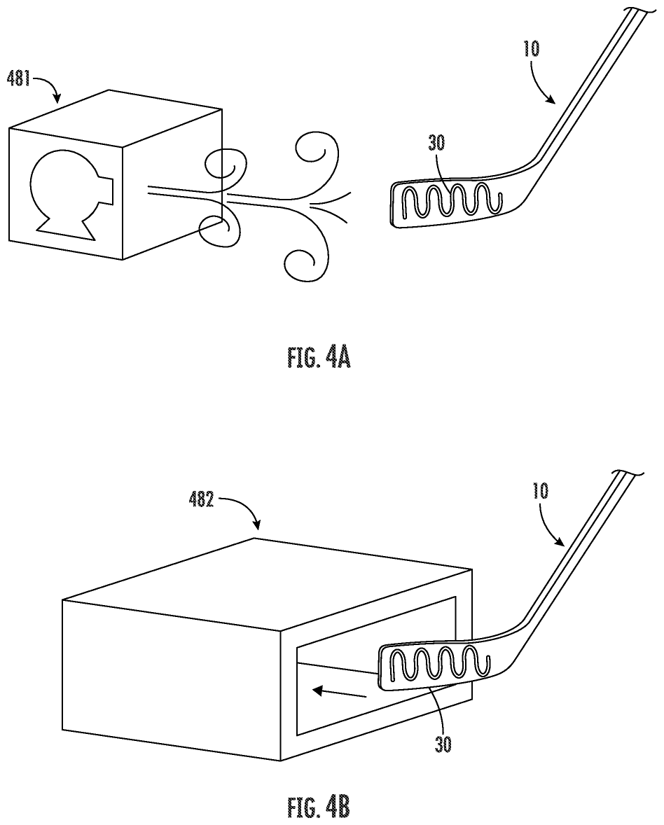

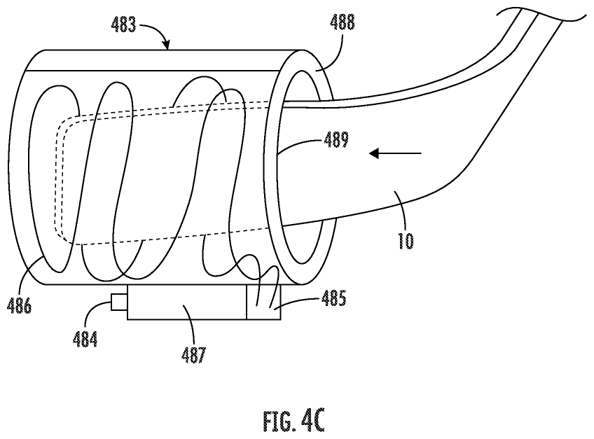

FIGS. 4A-C depict various external heating elements that may be used alone, or in combination with previously described heating system to supplement the process, such as a hot air blower, 481, a heating box 482, or a heating sleeve 483 having a switch device 484.

Heating sleeve 483 may include similar components as described above in connection with the presently described heated hockey sticks, such as a heating element 486, a power source 487 coupled to heating element 486, and wires 485 connecting power source 487 and heating element 486. Upon actuation of switch device 484, heating sleeve 483 will begin to heat up as power source 487 is enabled. The components of sleeve 483 may be contained within heating sleeve 483 in the space between an outer sleeve layer 488 and an inner sleeve layer 489. In practice, a player places heating sleeve 483 over the blade of a hockey stick while on the bench or in between shifts to further facilitate de-icing the hockey stick.

In embodiments, hockey sticks in accordance with the present disclosure may utilize a thermal structures (not shown) such as a thermal store or heat sink that can retain or dissipate thermal energy. A thermal store within the blade may prolong heat dissipation, effectively maintaining the temperature of the blade for an extended period of time in lieu of continuous operation of the heating element. The thermal store may include materials of varying phase (e.g., solids, liquids, and gels) and thermal properties. This material may form an interior core (also, “thermal core”). It has been found that rice (or like particulate and/or granulated material) can serve as the thermal core. It is contemplated that other configurations of the thermal core can be optimally arranged to both retain thermal energy from the heating element within the blade and to dissipate heat to the shaft.

While several embodiments have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of presently disclosed embodiments. Thus, the scope of the embodiments should be determined by the appended claims and their legal equivalents, rather than by the examples given.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Various alternatives and modifications can be devised by those skilled in the art without departing from the disclosure. Accordingly, the present disclosure is intended to embrace all such alternatives, modifications and variances. As well, one skilled in the art will appreciate further features and advantages of the present disclosure based on the above-described embodiments. Accordingly, the present disclosure is not to be limited by what has been particularly shown and described, except as indicated by the appended claims.

1. A heated hockey stick comprising:
a shaft;
a blade secured to a lower portion of the shaft;
a power source contained within the shaft; and
a heating element connected to the power source, the heating element configured to heat at least the blade of the hockey stick when the power source is enabled.

2. The heated hockey stick of claim 1, wherein the heating element generates heat using electricity, battery power, conduction, convection, or chemical reactions.

3. The heated hockey stick of claim 1, wherein the heating element is contained within the blade of the hockey stick.

4. The heated hockey stick of claim 3, wherein the heating element comprises a heating coil.

5. The heated hockey stick of claim 4, wherein the power source comprises a battery.

6. The heated hockey stick of claim 5, wherein the battery is rechargeable.

7. The heated hockey stick of claim 1, wherein the power source is coupled to a switch device, the switch device being actuatable, such that when the switch is actuated, the power source is enabled.

8. The heated hockey stick of claim 7, wherein the switch device is actuated manually.

9. The heated hockey stick of claim 7, wherein the switch device is actuated automatically, and is contained in the shaft of the hockey stick.

10. The heated hockey stick of claim 9, wherein the power source is coupled to a control unit, the control unit configured to automatically monitor the temperature of the blade of the hockey stick.

11. The heated hockey stick of claim 10, wherein the control unit is further configured to actuate the switch device, thereby enabling the power source, when the blade of the hockey stick is below a set temperature.

12. The heated hockey stick of claim 3, further including a thermal structure comprising a thermal store for prolonging maintenance of the heat generated by the heating element within the blade.

13. The heated hockey stick of claim 12, wherein the thermal store comprises materials of varying phases, gels, or rice.

14. The heated hockey stick of claim 7, wherein the heating element is positioned around the outside of the blade, the heating element being covered by a layer of protective material.

15. A heating sleeve for heating a hockey stick blade comprising:
a power source; and
a heating element connected to the power source, the heating element configured to heat the heating sleeve when the power source is enabled,
wherein the power source and the heating element are contained between an inner layer and an outer layer of the heating sleeve, the heating sleeve configured to receive a blade of a hockey stick therein.

16. The heating sleeve of claim 15, wherein the power source is coupled to a switch device, the switch device being actuatable, such that when the switch is actuated, the power source is enabled.
